(19) United States
(12) Patent Application Publication
(10) Pub. No.: US 2022/0202021 A1
(43) Pub. Date: Jun. 30, 2022

(54) Dynamic Modulation and Binarization of Heating Profile and Conveyance System within an Oven for Heating Based on Energy Availability

(71) Applicant: De Luca Oven Technologies, LLC, Sand City, CA (US)

(72) Inventor: Nicholas P. De Luca, Carmel-by-the-sea, CA (US)

(21) Appl. No.: 17/619,928

(22) PCT Filed: Jun. 19, 2020
(86) PCT No.: PCT/US2020/038618

§ 371 Date: Dec. 16, 2021

Related U.S. Application Data
(60) Provisional application No. 62/863,346, filed on Jun. 19, 2019.

(51) Int. Cl. A21B 1/24; A21B 1/22; A21B 1/46; A21B 1/40

(52) U.S. Cl. CPC A21B 1/245; A21B 1/40; A21B 1/46; A21B 1/22

(57) ABSTRACT

An oven system to heat a moving item includes a conveyor capable of moving at more than one speed along a path of movement; a heat source positioned along the path of movement; a baseline heating profile for heating the moving item at a constant velocity; a sensor to detect energy available for the heat source at a particular moment or over a period of time; and a system to dynamically modify, based on the energy available, the baseline heating profile into a modified heating profile including a variable conveyance speed, where, when the moving item exits the oven system, the energy supplied by the heat source to the moving item equals the energy to be supplied per the baseline heating profile.

### CROSS-REFERENCE TO RELATED APPLICATIONS AND INCORPORATION BY REFERENCE

The present application is a National Stage Application PCT Application No. PCT/US2020/038618, filed Jun. 19, 2020, and claims the benefit under 35 U.S.C. 119(e) of U.S. Provisional Application Ser. No. 63/194,783, filed May 28, 2021, which are incorporated herein by reference in their entirety.

### FIELD

The present disclosure teaches a method of modulating the radiative heating characteristics of one or more heating elements as well as the conveyance system through the oven based on the energy that is available to the heater or to a group of heaters within a high-speed oven. The system is extendable to a group of high-speed ovens further sharing an energy source such as grid power, power supplies, batteries, capacitors or a combination thereof. The heater elements used in the present teachings allow for them to be quickly switched. Exemplary heater elements include radiant heaters characterized as generally having a low electrical resistance of less than 0.5 ohms, a low thermal mass of less than 0.25 grams per square centimeter, and a large surface area so as to be turned on and off with a peak radiating spectrum of 0.5-3 microns infra-red within a few seconds, bulbs that may operative at high or low voltage, or when using a heating fluid such as with an air impingement oven and associated valving and blowers.

The overall system uses a baseline heating profile to impart a specific amount of energy onto the single or multiple food or non-food items and said profile modified in consideration of the energy available or power being delivered by the energy source to the heater element, and the simultaneous modification of the speed of the item conveyance system through the oven. The present teachings are especially useful for energy restricted environments such as areas with fluctuating grid power, high power ovens, and mobile or remote oven applications.

### BACKGROUND

The use of heater mesh is fully described by De Luca in U.S. Patent number US20100166397 as a means to safely deliver high power at a low voltage to an oven heating cavity. Typical means described by De Luca for delivering a high power output at a wavelength of 1-3 microns (which is most ideal for cooking food items such as toast) involves use of an element which when forming an oven of 0.25 m×0.25 m with a top and bottom element in parallel has the typical characteristic of having a ratio of its resistance to a black body radiative surface area of less than 2 ohms/m2. A similar mesh can also be created with flat stock material formed by a punching, waterjet cutting, chemical etching, laser cutting, electrical discharge machining, or other processes and could be considered an obvious extension for someone skilled in the field. Creating a mesh with a cut pattern that is tailored to provide the correct resistance at an appropriate driving voltage such as 12-24 volts is a further extension of the art and this mesh will have a DER of less than two if formed into an oven with a cooking area of 0.25 meters by 0.25 meters for a typical oven (or 0.0625 m2).

In U.S. provisional patent applications 62/730,878 “Multi Planar Heater Element for Use in a High-Speed Oven”, 62/730,893 “Heater Element Incorporating Primary Conductor for Use in a High-Speed Oven”, and 62/801,750 “Multi Planar Heater Element for Use in a High-Speed Oven Incorporating a Novel Tensioning System”, novel mesh heater elements are described having properties that make them suitable for use in a high-speed oven such as conveyor ovens. In US pending application US20160345591A1, a continuous heater element renewal system is described that is further applicable to conveyor ovens that have significant variable throughput such as applications in which the time, the heating cycle required, and number of items placed through the oven varies. Applications in which a changeable heating condition might be seen include intermittent batch process heating, the curing of rapid prototyped parts, the curing or drying of paint at a residential or commercial location, on-demand cooking such as at a restaurant, at a vending machine, at a stadium food kiosk, at a convenience store, or a food truck, as well as remote controlled heating applications.

In PCT patent application WO20141055457A1, De Luca describes a continuous conveyor belt oven wherein one or more heater elements are placed along a conveyor belt and selectively turned on and off to cook or heat an item based on a predetermined cooking profile. The oven may use a continuous conveyor motion to form a cooking recipe based on the specific location of the item and the combination of rapid start-up heaters that can be pulsed.

In comparison to other conveyor ovens that require a constant power input and pre-heating of the oven so as to create a “reservoir” of heat, on-demand rapid start-up heating only turns the heating elements on during or in close proximity in time to the actual cook cycle. Typical conveyor ovens include the Vollrath SO4 unit, the Edge 3240 pizza oven, the Hatco TPT toaster, the Despatch Industries W5 system, and the Middleby Marshall PS-520 pizza oven. These ovens generally require that the oven be preheated to the required operating temperature and the temperature maintained while items are not being cooked. Typical ramp up times of 15-20 minutes are common for ovens to achieve a typical operating temperature of 500 degrees when starting at room temperature. Costs associated with wasted heat and start-up time as well as ancillary costs associated with removing the wasted heat through venting or air conditioning can be high. Noise pollution of the work environment during slow periods is an additional result of the “constant on” condition of these ovens as well as the environmental impact of these ovens.

As an example, consider the US 2019 pizza industry according to IBIS World (March 2019) of $47 Billion and 93,000 stores; assuming an average pizza cost of $10 and that each store is open 7 days a week with 11 operating hours a day, each store therefore cooks about 138 pizzas a day. If a typical pizza takes 6 minutes to cook, and each store has at least 2 ovens, then each oven would be operating 62% of the day. In stores that operate 24 hours a day this use efficiency would drop to 28% use during the day (i.e. each oven idling 72% of the day). In a convenience store, the same oven usage characteristics may be even worse as the volume of pizza sales are significantly lower. Further assuming that 1000 W are used by each oven while standing by, simply to maintain the temperature required, each oven pair would use 8.36 KwHrs of energy each day while idling. Extended to a yearly period over all pizza stores, this equates to 283.8 Million Kilowatt-Hours of wasted energy or the equivalent of a 32.4-Megawatt power plant operating in a year or enough energy to power 32,000 homes for a year. This same example can be expanded to other industries and markets.

One of the other limitations of existing ovens and conveyor ovens is that they are generally unable to maintain a temperature of over 500 degrees. As an example, many foods including pizza cook well and quickly at a high temperature of 900-1200 degrees. Per the Stefan-Boltzmann law: J=σT⁴.

The radiated energy J is a function of the fourth power of the temperature T times the Stephan Boltzman constant σ. Thus, if the temperature of the oven is two times as high, the radiated energy will be 16 times as much, leading to significant and expensive losses if the oven if sitting idle for 50% or more of the time.

Like most ovens, the temperature control of conveyor ovens is adjusted via a thermostat and in the case of most conveyor ovens, the speed of the belt allows for more or less energy to be imparted to the item. Some pizza ovens like the Middleby Marshall PS-520 use heated air that circulated within the oven cavity and then impinged on the food item as it moves on the conveyor. Such impinger types of ovens may have the ability to increase or decrease the velocity of the blower so as to modulate the heat applied. These programmed setting may include oven temperature, conveyor speed, and blower speed, yet, the settings remain fixed throughout the heating of an item as it passes and generally require some time (on the order of several minutes or more) to change.

In order to assure consistency of the product produced within the aforementioned ovens, the use of a conveyor that has a constant velocity is critical as is the steady state temperature within the oven (and the blower velocity in the case of an impingement oven). As the reaction time is generally 1-10 minutes for changing the temperature of the oven (representing all or most of the cook time for the food), once an item has been placed on the conveyor, the velocity needs to remain the same in order to insure consistent cooking of the product. In some cases, items can be placed through a conveyor oven multiple times or removed early so that the item is heated correctly; such may be the case with cooking a pizza and chicken wings within the same conveyor oven.

In contrast, a high-speed oven as described in patent application WO20141055457A1, uses heating elements that can reach 900 degrees F. within a few seconds; a very short time with respect to the cooking of a pizza within the oven (on the order of 0.5-3%). Thus, cycling of the elements on and off can be done quickly so as to impart a different quantity of energy to the item. Despite the ability to flexibly change heat “recipes” by adjusting the speed of the conveyor belt as well as the on-off cycling of the heater elements, this must be done before the item is inserted into the oven (assuming the same energy profile is desired) as the parameters become interrelated to impart a fixed amount of energy on the item as it moves through the oven within a set period of time. Another limitation is that these ovens use high power elements which if all turned on simultaneously would require large power loads that restaurants typically don't have.

Another limitation of the existing ovens is that they rely on a predictable energy input from the power outlet. In many locations where power is not reliable and brown outs are common, the oven temperature can fluctuate and the resulting product produced is inconsistent. This unintended power interruption or unreliable input can also affect the transformers or power supplies that are powering the heating elements. In the case of using stored energy from devices such capacitors and batteries to power the heating elements in a conveyor oven, drops in voltage can significantly affect the temperature of the heater elements and thus the overall oven performance. The inability to correct the recipe for this low power or low temperature condition is therefore a significant existing problem.

In some cases, as described in FIG. 9 of co-pending application WO2013166519A1 “Accelerated heating, cooking, and dispensing incorporating a stored energy oven in a mobile apparatus”, the current and voltage can be measured and a specific number of joules imparted to the food item. In this case, the conveyor simply moves the food to a fixed position and the heat is imparted by one or more elements; once cooked, the item is moved out of the oven. As the conveyor is stationary during the cook cycle, additional pizzas cannot be simultaneously moved into the oven, thus removing a significant benefit from the system.

It is therefore a primary objective of the following invention to provide for conveyor oven that allows for different items to be placed on the conveyor and allow for variable heating profiles to be achieved while the conveyor is moving.

It is another object of the current invention that the heat energy in the oven be flexibly allocated and used so as to maximize the efficiency of the oven.

It is a further objective of the following invention that the oven enable the proper heating of an object as it passes through the oven despite input energy deficiency or surplus.

It is another object of the current invention that the oven provide high efficiency and remain generally off when not in use.

It is a further purpose of the following invention to allow for the construction of flexible cooking recipes that can adjust for variable conveyor speeds, oven temperatures, blower temperatures, blower speeds, power availability, object type and placement.

### SUMMARY

The present teachings provide embodiments of a novel energy distribution system within a conveyor oven design, and features thereof, which offer various benefits. The system including an oven with a conveyor capable of moving at more than one speed, one or more heat sources positioned along the length of the conveyor, (including heater elements having a DER of less than 2 or air impingement nozzles), reflectors or isolators intended to maintain the heat of a particular heating element within a defined region, sensors or inputs to detect or define the size and type of object or objects placed on the conveyor belt prior to entry into the oven, a predefined heating recipe intended for heating the items through the oven at a constant velocity of the belt or a predefined temperature profile required, sensors to detect the energy available at a particular moment or over a period of time including voltage, current, temperature, and air velocity sensors, a system that correlates the appropriate speed for the conveyor to travel based on the energy availability, and means of quickly modulating the amount of heat applied to the product including the use of valves, multiple blowers, or heating elements capable of switching off extremely quickly.

Use of the oven involves first placing the object to be processed on the conveyor prior to entry into the oven. Upon inspection or definition of the item, a heating profile is identified; this may include an average temperature marker or peak required for the item and a standard profile within the oven when the items passes through at a constant velocity. Based on the baseline speed of the item passing and heating profile, a model can be simulated to assign blocks of energy associated with position and time to be imparted by one or more of the heating units within the oven. Further, by measuring the energy available from the power source of a high-speed heating element or the temperature and velocity of air through an air impingement fork, the speed of the conveyor can be modulated along with the heat delivered by the heat source modulated (via switching, valving, or blower speed) so as to insure consistent product heating within the shortest period of time.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. An oven system to heat a moving item includes a conveyor capable of moving at more than one speed along a path of movement; a heat source positioned along the path of movement; a baseline heating profile for heating the moving item at a constant velocity; a sensor to detect energy available for the heat source at a particular moment or over a period of time; and a system to dynamically modify, based on the energy available, the baseline heating profile into a modified heating profile including a variable conveyance speed, where, when the moving item exits the oven system, the energy supplied by the heat source to the moving item equals the energy to be supplied per the baseline heating profile. Other embodiments of this aspect include corresponding computer systems, apparatus, and computer programs recorded on one or more computer storage devices, each configured to perform the actions of the methods.

Implementations may include one or more of the following features. The oven system where the conveyor is variable speed and its speed can be adjusted under computer control. The heat source includes one or more heaters having a ratio of resistance to blackbody radiative area of less than 2. The heat source includes one or more heaters powered by less than 48 volts. The heat source includes one or more bulbs. The heat source includes using blown air. The heat sources include reflectors or isolators intended to maintain the heat of a particular heating element within a defined region.

The sensors may include one or more of the following: a voltage sensor, a current sensor, a temperature sensor, and an air velocity sensor. The baseline heating profile and any change to the profile may include a sequence of on and off times for each of the heat sources. The baseline heating profile and any change to the profile may include a change in the velocity of air flow. The baseline heating profile and any change to the profile may include a change in the volume of air flow. The baseline heating profile may include the energy imparted by each heat source or heater and where said baseline heating profile can be changed so as to deliver the same resulting energy to an item passing through the oven over a different period of time. The adjustment of the baseline heating profile and conveyor speed may occur in a period of 10 to 30 seconds. The adjustment of the baseline heating profile and conveyor speed may occur in a period of 1 to 30 seconds. The adjustment of the baseline heating profile and conveyor speed may occur in a period of 0.001 to 1 seconds. The heat source may reach 500 degrees F. within 5 seconds. The heat source may reach 900 degrees F. within 5 seconds. The baseline heating profile may relate to the length of one or more of the items to be heated through the oven. The object length of the item may be detected using a sensor such as a camera, a weight sensor, a laser, a diode, a reflector, a hall effect sensor, an RFID sensor, or an ultrasonic sensor. The object length may be detected using a manual selection such as a push button or knob. A length of the moving item may be recognized by a camera or other sensor such as a camera, a weight sensor, a laser, a diode, a reflector, a hall effect sensor, an RFID sensor, or an ultrasonic sensor.

The baseline cooking profile for the object may be retrieved from a database such as an electronic memory. The baseline cooking profile for the object may be detected using a manual selection such as a push button or knob. The baseline cooking profile of an item to be heated through the conveyor may be combined with the baseline cooking profile of one or more items already passing through the oven. The baseline cooking or temperature profile of an item in the oven may be modified based on the input from a temperature or other sensor monitoring the item within the oven. The heat source may include using induction heating. The heat source may include using a fluid such as air, oil, water, or steam. The heat source may include using microwaves. The heat source may include using conductive heating. The oven may be mounted to a moving vehicle. The power source may include a generator. The power source may include using blown air.

The oven may include at least one heater element that is capable of reaching 900 degrees F. within 5 seconds and where said heating element is formed like two end to end U's that together forming a circular path. The oven where the powering of the heater element may occur at a central location that does not move. Two or more of the heater elements may be connected along the path of a conveyance system through the oven. Other embodiments of this aspect include corresponding computer systems, apparatus, and computer programs recorded on one or more computer storage devices, each configured to perform the actions of the methods.

One general aspect includes a process for using a conveyor oven may include placing an item on a conveyance system, selecting the object length and baseline cooking profile, adjusting the heating profile before or heating through the oven based on the existing or future items to be heated through the oven and synchronizing the conveyance speed accordingly so as to impart the correct energy to the item by the time it exits the oven. Other embodiments of this aspect include corresponding computer systems, apparatus, and computer programs recorded on one or more computer storage devices, each configured to perform the actions of the methods.

It is to be understood that both the foregoing general description and the following detailed description are exemplary and explanatory and are intended to provide further explanation of the invention as claimed.

### BRIEF DESCRIPTION OF THE FIGURES

The accompanying drawings, which are included to provide a further understanding of the invention and are incorporated in and constitute a part of this specification, illustrate embodiments of the invention, and together with the description serve to explain the principles of the invention.

FIG. 1A is an isometric drawing of a single or multiple flat wire mesh heater elements, according to various embodiments.

FIG. 1B is an isometric drawing of an end to end flat wire mesh single or multiple layer heater element that is centrally powered, according to various embodiments.

FIG. 1C is a photograph of an impingement air heater element, according to various embodiments.

FIG. 2 is a photograph of multiple flat wire mesh heater integrated within an oven cavity, according to various embodiments.

FIG. 3 is an isometric drawing of a pizza placed on a conveyor belt oven, according to various embodiments.

FIG. 4 is a two-dimensional drawing of an item placed on a conveyor oven further indicating the key dimensional parameters associated with the novel oven and energy system herein described incorporated with the heater elements of FIGS. 1A and 1B.

FIG. 5 is a is a two-dimensional drawing of an item placed on a conveyor oven further indicating the key dimensional parameters associated with the novel oven and energy system herein described incorporated with the air impingement heaters of FIG. 1C.

FIGS. 6a and 6b are schematic diagrams indicating those elements of a dynamically modulated conveyor oven, according to various embodiments.

FIG. 7 is a table showing a cooking recipe associated with a high-speed constant velocity conveyor oven that is dynamically modulated, according to various embodiments.

FIG. 8 is a table showing a conveyor speed control to decrease the power requirement of the oven when running two items immediately one after the other, according to various embodiments.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DESCRIPTION

The present teachings disclose a method of modulating the radiative heating characteristics of one or more heating elements as well as the conveyance system through the oven based on the energy that is available to the heater or to a group of heaters within a high-speed oven.

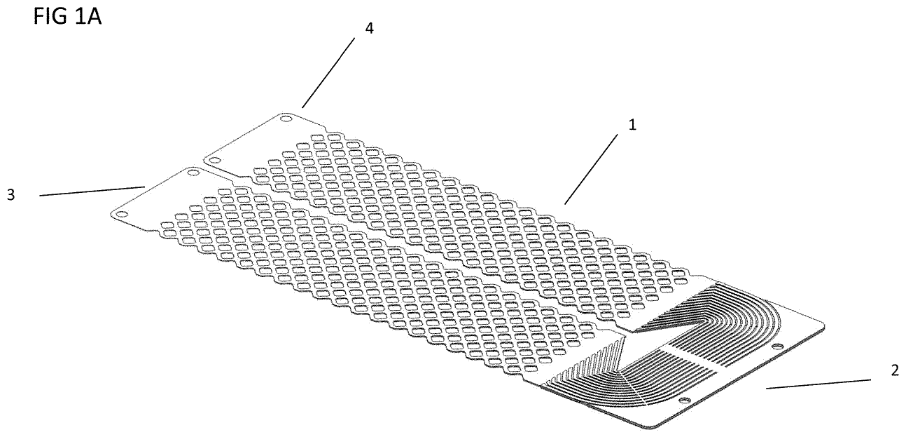

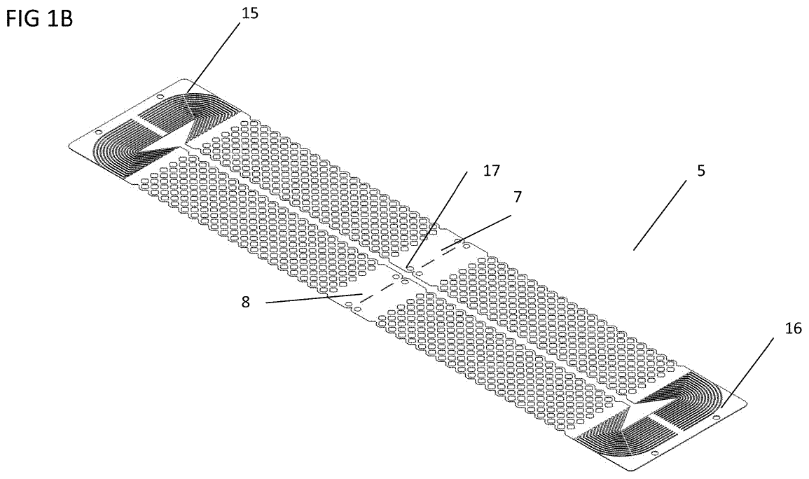

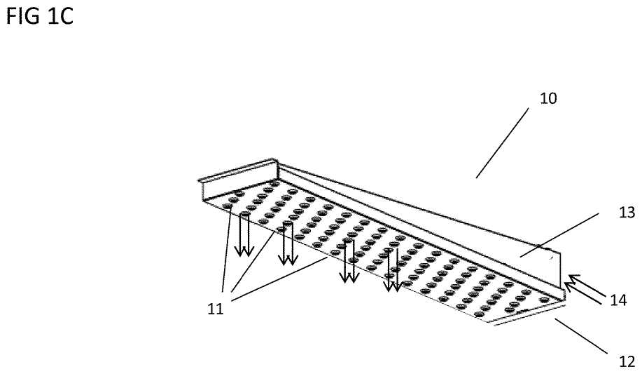

FIGS. 1A and 1B show heating elements 1 and 5 further described in U.S. Patent number US20100166397, U.S. provisional patent applications 62/730,878 “Multi Planar Heater Element for Use in a High-Speed Oven”, 62/730,893 “Heater Element Incorporating Primary Conductor for Use in a High-Speed Oven”, and 62/801,750 “Multi Planar Heater Element for Use in a High-Speed Oven Incorporating a Novel Tensioning System”. These heater elements all have the ability to achieve an operating temperature of 700-900 degrees C. within 3 seconds and thus can be termed “instant on” radiative heaters. Per the prior art, heater 1 of FIG. 1A has fixed ends 3 and 4 through which a low voltage high current is applied, such as 105 amps at 24V (thus 2520 W). Tensioning is applied at the other end using springs or other tensioning means. In FIG. 1B, a novel high-speed heating element 5 is shown having ends for tensioning 15 and 16 and power capable of being applied at the center of the element 17 through connections at 7 and 8, typically 210 amps at 24V. The central connection 7 and 8 being useful for allowing a lower voltage to be used for a heater element that maintains a De Luca Element Ratio of less than 2 (see prior art for description and definition), and can be operated at a large width (i.e. 14-26 inches) typical for cooking items such as pizzas.

In FIG. 1C a typical heater air blowing duct or “finger” 10 is shown that is used in conjunction with an air impingement conveyor oven. Air 14 enters the duct 13 at entrance 12 and then impinges the item by exiting nozzles 11. In some cases, finger 10 can be combined with heater flat mesh wire heater 1 or 5 such that the air exiting ports 11 passes through or over the wire flat mesh 1 and 5 and is heated in doing so. Although the air 14 passing through nozzles 11 cannot be quickly cooled or heated, the stopping of the air flow in duct 13 or at nozzles 11 can be accomplished quickly as can stopping the air flow 14 via stopping the blower or using bypass valves. As with heater elements 1 and 5, the heat blower element 10 can be used to quickly apply heat to an item passing through a conveyor oven and can be easily switched “on” and “off”. This ability to switch the heater on and off is critical to the “binarization” of the heating profile and the ability to “move” binary components of the heating recipe in order to maximize the efficiency of the oven as herein further described.

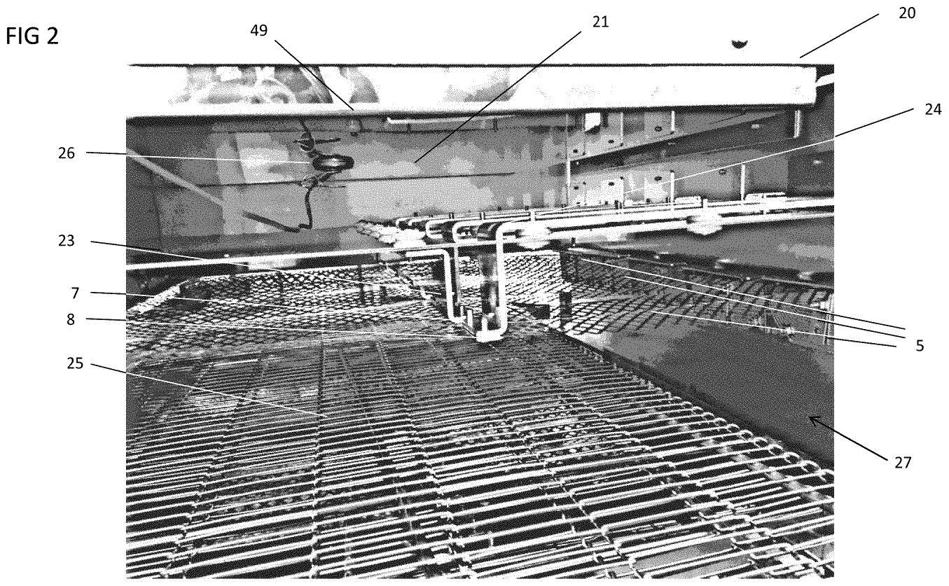

FIG. 2 is a photograph of a conveyor oven 20 wherein nine of heater element 5 of FIG. 1B are secured with connected power ends 7 and 8 to power leads 23 and 24 respectively. Conveyor belt 25 moves into the oven cavity 21 in direction 27. Temperature sensor 26 or other sensors can be used to characterize the condition of one or more items passing through the oven as well as the overall temperature or other parameters such as humidity and particulate concentration. Reflectors 49 can also be used to modulate heat reflecting from the heaters and further imparted to the item on conveyor 25.

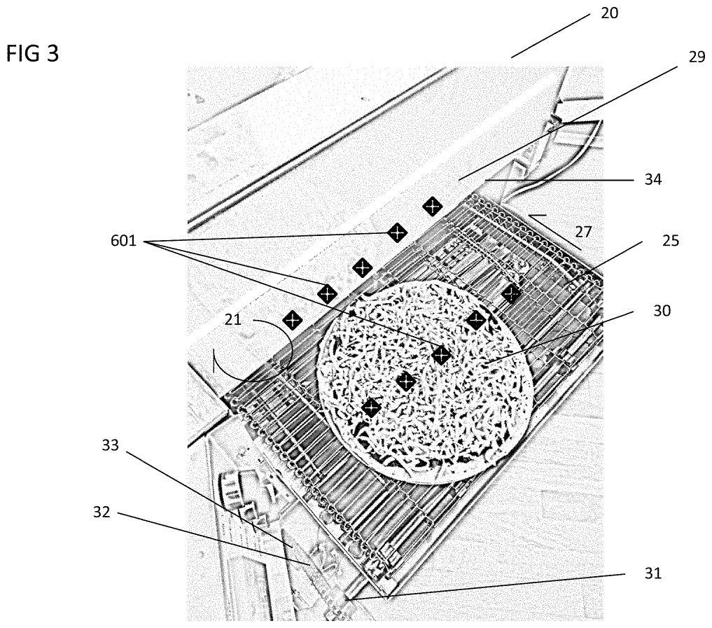

FIG. 3 is an isometric drawing of the conveyor belt oven 20 having conveyor belt 25 moving in direction 27. Shielding 29 covers most of the opening to the oven cavity 21 shown in FIG. 2 with a leading edge 34 through which pizza 30 passes. Sensors 601 identify the location and/or the dimension of pizza 30 and this information is further used to modulate the speed of motor 33 that drives chain 32 and moves conveyor 25 via shaft 31. In addition, sensors 601 may include temperature sensors or other sensors to characterize the pizza 30 and help modulate its associated cooking profile.

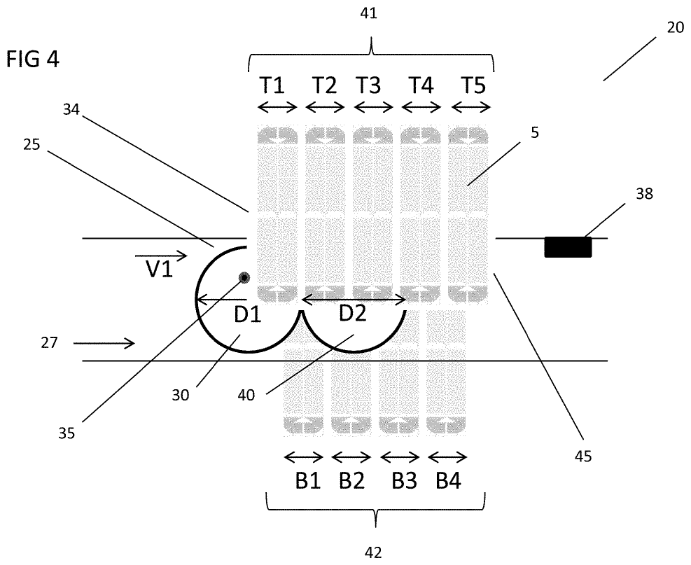

FIG. 4 is a schematic diagram of oven 20 with leading edge 34, conveyor 25, moving in direction 27 at velocity V1, with pizza 40, having diameter D2, fully in the oven and pizza 30, having diameter D1, partially in the oven, and five of heating elements 5 forming a top array 41 and four of heating element 5 located below the conveyor and forming array 42. The respective diameters D2 and D1 of pizzas 40 and 30 having been identified through measurement using sensor or sensors 35 and the time that pizzas 30 and 40 pass under each eater element 5 can be indicated by T1-T5 on the top array 41 and B1-B4 on the bottom array 42.

As an example, the following times can be used to assess the period during which the heater elements would be on when a single 10″ pizza passes completely through a 20″ continuous conveyor oven operating at a constant velocity of 5.9 in/min with 4 inch wide heater elements; the pizza 30 takes 5.1 minutes to traverse a distance of 30″ as the leading edge of the pizza passes edge 34 of the oven and the trailing edge of the same pizza passes the oven end 45.

| | |
|---|---|
| Pizza Size (in) | 10 |
| Inches/Min | 5.9 |
| Actual Time (min) | 5.1 |

| | | End |
|---|---|---|
| | Start | (sec) |
| Top Element 1 | 0 | 142.8 |
| Top Element 2 | 40.8 | 183.6 |
| Top Element 3 | 81.6 | 224.4 |
| Top Element 4 | 122.4 | 265.2 |
| Top Element 5 | 163.2 | 306 |
| Bottom Element 1 | 20.4 | 163.2 |
| Bottom Element 2 | 61.2 | 204 |
| Bottom Element 3 | 102 | 244.8 |
| Bottom Element 4 | 142.8 | 285.6 |

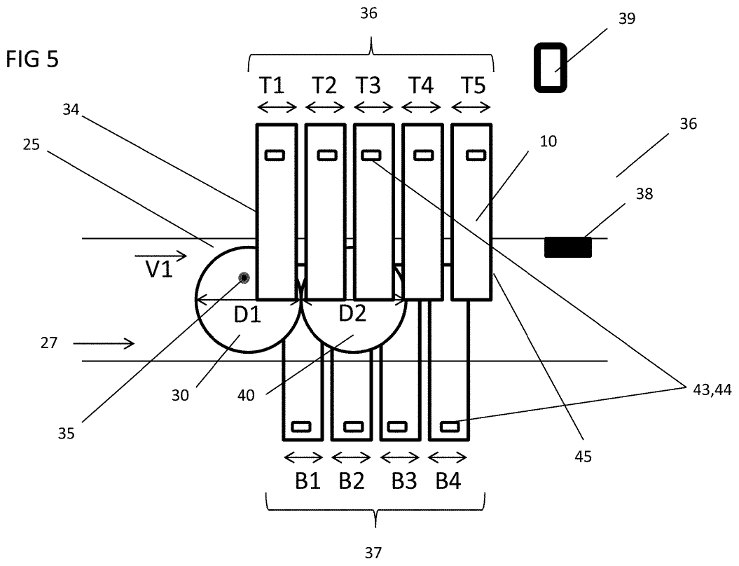

Similarly to oven 20 in FIG. 4, FIG. 5 is a schematic of oven 36 showing leading edge 34, conveyor 25, moving in direction 27 at velocity V1, with pizza 40, having diameter D2, fully in the oven and pizza 30, having diameter D1, partially in the oven and having measurement sensor or sensors 35. Instead of utilizing heater element 5, the oven of FIG. 5 utilizes top array 36 and bottom array 37 of air impingement heater 10 with primary blower 39 forcing air through the ducts of arrays 36 and 37. By using individual valves 43 and/or individual blowers 44 located at each of impingement fingers 10, the hot fluid such as air can be controlled at each individual finger. In some cases, impingement heater 10 can use other fluids such as oil or water or steam for imparting heat; conductive heat, microwave heating, induction heating, are other methods and combinations of heaters including radiant IR, microwave, conduction, induction, and impingement can be used and defined as having an energy imparted to the item to be heated.

As in FIG. 4, the time that pizzas 30 and 40 pass under each heater element 10 can be indicated by T1-T5 on the top array 36 and B1-B4 on the bottom array 37. By varying the velocity of conveyor 25, the values of times T1-T5 and B1-B4 change accordingly and, assuming a constant flow of energy from the heaters 5 and 10, the energy that is imparted to pizzas 30 and 40 varies inversely with the best speed. Also note that if cycling on and off, the actual time that a heater is on is a function of the percentage of the total time that the pizza is under the heater; for example, if T1=10 seconds and cycling is set to 50%, then time on=5 seconds.

Representing this mathematically for a constant velocity,

$${T}_{on} = Total Time T under element \cdot \% ON .$$

Further, if the width along the direction 27 of heater element 5 or 10 is given as X and the velocity V1 of conveyor 25 is given as a multiple Y of X per second or termed:

$${V}_{1} = Y \cdot X / sec$$

Therefore if the energy imparted per second or joules/second, or watts at each of the heater elements of arrays 36,37, 41, and 42 at T1-T5 and B1-B5 can be expressed as W(T), then the total energy imparted “E Total” on pizzas 30 and 40 individually if the elements deliver constant power, equals:

$${E}_{Total} = {\sum }_{T 1 - T 5} W ( T ) \cdot ( X / {V}_{1} ) + {\sum }_{B 1 - B 4} W ( T ) \cdot ( X / {V}_{1} ) \qquad Eq . 1$$

An oven having 9 heater elements that each operate at 2500 W would have a total continuous power requirement of 22,500 W if the elements were all turned on at once; this would be difficult to provide from wall power and could easily burn the item. Selectively choosing the operational element and further cycling elements on an off is one way to limit the total power usage. This can be done by modulating a specific % on time as each item passes over or under an element effectively limits this power. Using cooking recipes that evenly distribute power distribute among all the heater elements are most efficient. Incorporating this “% on” value to Eq. 1 gives a new value to “E Total”=

$${E}_{Total} = {\sum }_{T 1 - T 5} W ( T ) \cdot ( X / {V}_{1} ) \cdot \% on + {\sum }_{B 1 - B 4} W ( T ) \cdot ( X / {V}_{1} ) \cdot \% on \qquad Eq . 2$$

Therefore, Y can be modulated such that if Y=2 (i.e. the velocity of the conveyor is sped up twice as fast as 1 element width per second) then “% on” can be increased 2x such that E Total is equivalent; this assumes that at Y=1, “% on”<50%.

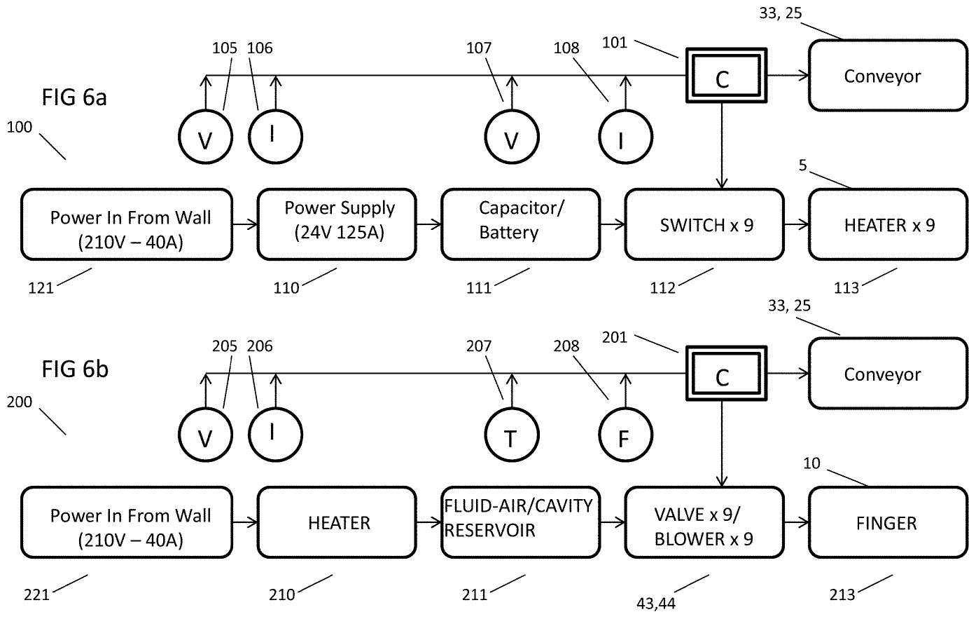

Eqs. 1 and 2 assume that the power delivered by each heater element is fixed and that the on-off modulation affects the power delivered. In the case of using a power source such as a stored energy source 111, a power supply 110, or a fluctuating wall source 121 as further shown in FIG. 6a, the monitoring of the voltage and current with sensors 105, 106, 107 and 108 into and out of the heater elements, power supplies, and stored energy supply is important to define W(T). Processor 101 can modulate “Y” and simultaneously the conveyor 25 and associated motor velocity 33 while changing the “% on” time such that the voltage and current remain at the appropriate levels to radiate heat. This monitoring and resulting modulation of the belt speed can be done over very short periods (i.e. less than 1 second) such that the average power delivered over the passage of the pizzas over or under an element 5 remains a constant per the associated recipe. The result is that the same amount of energy is applied to each section of the item as it passes through the oven. In some cases, a superimposed modulation can be applied to a predetermined recipe and further correlated to the conveyor speed; for example, to account for environmental conditions such as excessive cold or for oven temperature.

In FIG. 6b the process of monitoring the voltage and current of the wall power 221 that further goes to the fluid or air heater 211 with voltage and current sensors 205 and 206 is shown as well as the monitoring of the temperature with sensor 207 and flow rate 208 of the air or fluid medium directed through the impingement fingers 10. Processor 201 can modulate the individual valves and blowers 43, 44 such that the energy delivered is synchronized with the belt speed. In the case of using a fluid medium, the energy of each cubic volume of fluid directed at the pizzas 30 and 40 is a function of the temperature, fluid density, specific heat of the medium, absorption by the item, and the flow rate (which is further a function of the viscosity, pressure, and nozzle/duct characteristics).

By having a predefined energy block defined for a heat profile through the conveyor oven, the energy imparted can be calculated at any point in time and the energy transferred accordingly on a per block basis to hold a determined profile for the overall energy distribution over the item.

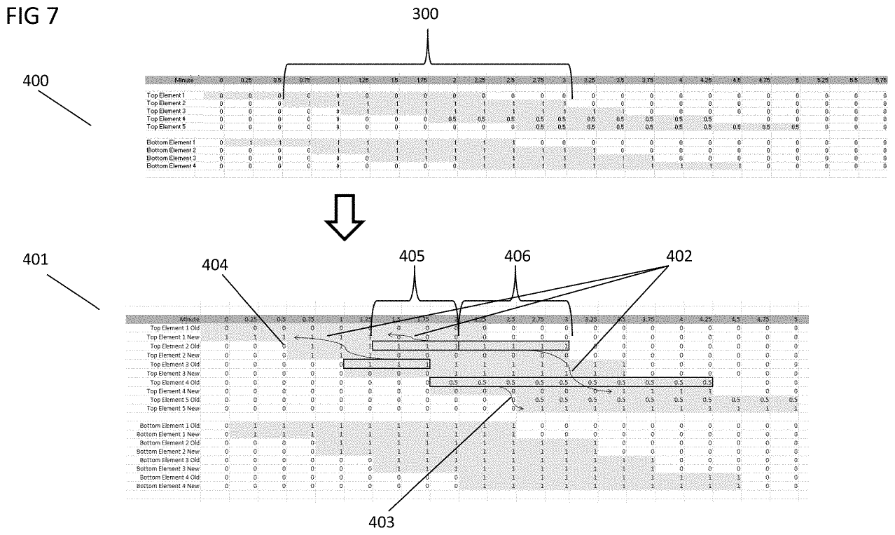

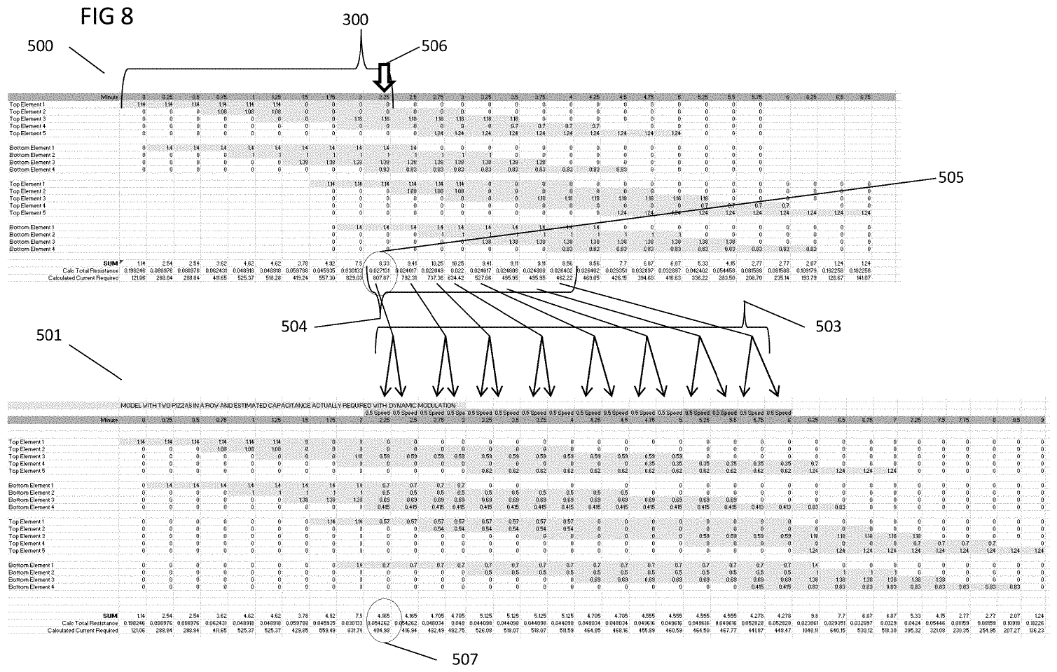

As an example, heating recipe 400 is shown in FIG. 7 with period 300 of 2.5 minutes or 150 seconds. Each period or block is further divided into 10 units or durations of 15 seconds that are either on or off. Each block that is on can also have a defined “% on” associated with the block as well as a relative resistive character (i.e. higher electrical resistance or greater flow resistance) and the “% on” modulates this value (as further seen in the tables shown in FIG. 8). Operating table 400 of FIG. 7 can be modified into operating table 401 by moving the segments 405 and 406 from 404 (“T2 old” in the old recipe) to the same block slots in T1 new and T3 new as indicated by 402. Similarly, T4 old operating at 50% on is added to T5 old 50% to yield T5 new operating at 100% (or as indicated as a 1 value by 403). As a whole, the new recipe behaves the same as the old one yielding the same finished product and imparting the same energy to the surface area of the item even though different heat elements are used and these are powered at different power levels from the original heat profile. Operating tables 400 and 401 utilize the same conveyor velocity and no time “dilation” is used.

On the other hand, in the example described in FIG. 8, the conveyor speed is controlled and slowed down by 50% so as to decrease the power requirement of the oven when running two pizzas immediately one after the other. Operating table 500 shows time block 300 of 2.5 minutes or 150 seconds and each block is further divided into 10 units of 15 seconds. The values are not strictly whole numbers as they represent the actual resistance or flow restriction of a particular heat element. As seen in the difference between operating Table 500 and Table 501, the individual time sections indicated by 504 are expanded into two columns each as the conveyor speed is slowed down by 50% during this time period and the new columns indicated by 503 formed. As easily, a time block from table 500 could have been expanded into 3 columns (effectively decreasing the conveyor speed 3× and the energy in each block section by ⅓). As indicated by arrow 506, beginning at time interval 2.25 min until 2.5 minutes, the current required in recipe 500 is 807 amps (at 505) while the same time interval in recipe 501 is 404 amps (at 507). This reduction enables greater energy flow from the power supplies to the oven and an overall increase in efficiency. The following table summarizes the benefits seen through the modification of operating table 500 into table 501 with the associated simultaneous reduction of conveyor speed in the periods indicated by 503.

| | Old | Dynamic |
|---|---|---|
| Total Time for Pizza 1 (sec) | 315 | 435 |
| Total Time for Pizza 2 (sec) | 315 | 435 |
| Total Radiant energy Imparted (MJ) | 3.33 | 5.24 |
| Minimum Voltage of System (V) | 12.2 | 17.05 |
| Average Voltage of System (V) | 19.21 | 22.72 |
| Average Power Operation (W) | 7924 | 10075 |
| Average Current (I) | 412 | 443 |
| Number of Supplies | 4 | 4 |
| Power Per Supply (W) | 1981 | 2519 |

The examples presented herein are intended to illustrate potential and specific implementations. It can be appreciated that the examples are intended primarily for purposes of illustration for those skilled in the art. The diagrams depicted herein are provided by way of example. There can be variations to these diagrams or the operations described herein without departing from the spirit of the invention. For instance, in certain cases, method steps or operations can be performed in differing order, or operations can be added, deleted or modified.

1. An oven system to heat a moving item, the oven system comprising:
a conveyor capable of moving at more than one speed along a path of movement;
a heat source positioned along the path of movement;
a baseline heating profile for heating the moving item at a constant velocity;
a sensor to detect energy available for the heat source at a particular moment or over a period of time; and
a system to dynamically modify, based on the energy available, the baseline heating profile into a modified heating profile comprising a variable conveyance speed,
wherein, when the moving item exits the oven system, the energy supplied by the heat source to the moving item equals the energy to be supplied per the baseline heating profile, and
wherein the baseline heating profile relates to a length of the moving item.

2. The oven system of claim 1 wherein the heat source include one or more heaters having a ratio of resistance to blackbody radiative area of less than 2.

3. The oven system of claim 1 wherein the heat source includes one or more heaters powered by less than 48 volts.

4. The oven system of claim 1 wherein the heat source comprises a reflector or isolator to maintain heat within a defined region.

5. The oven system of claim 1 wherein the sensor comprises one or more of a voltage sensor, a current sensor, a temperature sensor, and an air velocity sensor.

6. The oven system of claim 1 wherein the baseline heating profile and any change to the modified heating profile comprises a sequence of on and off times for the heat source.

7. The oven system of claim 1 wherein the baseline heating profile and any change to the modified heating profile comprises a change in an air flow velocity or a change in an air flow volume.

8. The oven system of claim 1 wherein the baseline heating profile comprises the energy imparted by the heat source and where the baseline heating profile is alterable so that the energy supplied by the heat source equals the energy to be supplied per the baseline heating profile.

9. The oven system of claim 1 wherein the system receives the energy available over a period of 10 to 30 seconds and modifies the baseline heating profile accordingly.

10. The oven system of claim 1 wherein the system receives the energy available over a period of 1 to 30 seconds and modifies the baseline heating profile accordingly.

11. The oven system of claim 1 wherein the system receives the energy available over a period of 0.0001 to 1 seconds and modifies the baseline heating profile accordingly.

12. The oven system of claim 1 wherein the heat source is able to reach 500 degrees F. within 5 seconds.

13. (canceled)

14. The oven system of claim 13 wherein the length is detected using one or more of a camera, a weight sensor, a laser, a diode, a reflector, a hall effect sensor, an RFID sensor, and an ultrasonic sensor.

15. The oven system of claim 13 wherein the length is indicated using a manual selection.

16. The oven system of claim 1 wherein the baseline heating profile for the moving item is indicated using a manual selection.

17. The oven system of claim 1 wherein the moving item comprises a first item disposed on the conveyor prior to a second item, and the baseline heating profile of the first item is combined with the baseline heating profile of the second item.

18. An oven system to heat a moving item, the oven system comprising:
a conveyor capable of moving at more than one speed along a path of movement;
a heat source positioned along the path of movement;
a baseline heating profile for heating the moving item at a constant velocity;
a sensor to detect energy available for the heat source at a particular moment or over a period of time; and
a system to dynamically modify, based on the energy available, the baseline heating profile into a modified heating profile comprising a variable conveyance speed,
wherein, when the moving item exits the oven system, the energy supplied by the heat source to the moving item equals the energy to be supplied per the baseline heating profile, and
wherein the baseline heating profile is modified based on a second sensor monitoring the moving item within the oven system.

19. The oven system of claim 1, wherein the heat source is capable of reaching 900 degrees F. within 5 seconds and wherein the heat source comprises end to end U-shaped heating elements that together have a generally circular shape.

20. A process for using a conveyor oven comprising:
placing an item on a conveyance system;
selecting a length and a baseline cooking profile conveyor for the item;
adjusting a baseline heating profile before or heating through the conveyor oven based on an existing or future item to be heated through the conveyor oven; and
synchronizing a conveyance speed accordingly so as to impart a correct energy to the item when the item exits the conveyor oven,
wherein the baseline heating profile relates to a length of the moving item.
